(19) United States
(12) Patent Application Publication
(10) Pub. No.: US 2026/0364833 A1
(43) Pub. Date: Nov. 19, 2026

(54) HAIR-CUTTING APPLIANCE AND CUTTING UNIT FOR A HAIRCUTTING APPLIANCE

(71) Applicant: WAHL GMBH, St. Georgen (DE)

(72) Inventor: Dominik WEISS, Kolbingen (DE)

(21) Appl. No.: 19/121,965

(22) PCT Filed: Nov. 7, 2023
(86) PCT No.: PCT/EP2023/081021

§ 371 Date: Apr. 17, 2025

(30) Foreign Application Priority Data
Nov. 7, 2022 (EP) 22205934.7

(51) Int. Cl. B26B 19/20; B26B 19/06; B26B 19/38

(52) U.S. Cl. CPC B26B 19/205; B26B 19/3886; B26B 19/06

(57) ABSTRACT

A hair cutting device is disclosed, including a blade arrangement with a first cutting element and a second, movable cutting element, a drive device which drives the blade arrangement and a cutting length adjustment device which interacts with the second cutting element in such a way that a longitudinal offset can be adjusted between the first cutting element and the second cutting element, wherein the hair cutting device further has a selector device with which the cutting length adjustment device can be adjusted between at least a first length adjustment mode and at least a second length adjustment mode, wherein in the first length adjustment mode the longitudinal offset can be adjusted in steps or continuously, and in the second length adjustment mode the longitudinal offset can be adjusted in steps.

### FIELD OF THE INVENTION

The invention relates to a hair cutting device and a cutting set for a hair cutting device.

### PRIOR ART

Hair cutting devices are known in the prior art and include, among other things, a blade assembly provided at a front end of the hair cutting device and suitable for cutting hair.

The blade assembly generally has two cutting elements, a first of which is firmly connected to the rest of the hair cutting device and a second of which is arranged to be movable relative to the first. Cutting elements with comb-like cutting edges are often used, in which case the first cutting element is designed as a so-called shearing comb and comes into contact with the skin of the person or animal to be treated or the user. The second cutting element is then designed as a so-called shearing knife. Each cutting element has a series of spaced apart teeth, wherein the teeth are typically arranged evenly spaced apart from one another. Such a blade arrangement can be designed so that different cutting lengths can be adjusted. The cutting length of such an adjustable blade arrangement is adjusted by longitudinally offsetting the two cutting elements relative to one another, with the movable cutting element generally being offset longitudinally.

Solutions for adjusting the cutting length are known from the prior art, which enable a continuous or stepwise adjustment. Both variants occur approximately equally often, with one or the other variant usually being preferred depending on the user. This means, particularly in hair salons with several hairdressers, that both continuously adjustable hair cutting devices and step-adjustable hair cutting devices are available, although the majority of these two variants are not in use. As a result, the hair salons in question have low machine efficiency, which reduces overall economic efficiency.

Solutions known from the prior art are therefore not very economical, inflexible and often do not offer the optimal adjusting option.

### DISCLOSURE OF THE INVENTION

The object of the present invention is therefore to overcome the problems known from the prior art, namely to provide a cost-effective, flexible and easily adjustable solution.

The object is achieved by a hair cutting device according to claim 1 and a cutting set for a hair cutting device according to claim 2. Further features configuring the invention are contained in the dependent claims.

A hair cutting device according to the invention comprises a blade arrangement with a first cutting element and a second, movable cutting element, a drive device which drives the blade arrangement, and a cutting length adjustment device which interacts with the second cutting element in such a way that a longitudinal offset can be adjusted between the first cutting element and the second cutting element, wherein the hair cutting device further has a selector device with which the cutting length adjustment device can be adjusted between at least a first length adjustment mode and at least a second length adjustment mode, wherein in the first length adjustment mode the longitudinal offset can be adjusted in steps or continuously, that is to say in a stepless manner, and in the second length adjustment mode the longitudinal offset can be adjusted in steps or continuously, namely is adjustable in a stepless manner, and in the second length adjustment mode the longitudinal offset can be adjusted in steps. Furthermore, a cutting set according to the invention for a hair cutting device comprises a blade arrangement with a first cutting element and a second, movable cutting element and a cutting length adjustment device which interacts with the second cutting element in such a way that a longitudinal offset can be adjusted between the first cutting element and the second cutting element, wherein the cutting set further has a selector device with which the cutting length adjustment device can be adjusted between at least a first length adjustment mode and at least a second length adjustment mode, wherein in the first length adjustment mode the longitudinal offset can be adjusted in steps or continuously, that is to say in a stepless manner, and in the second length adjustment mode the longitudinal offset can be adjusted in steps. Such a selector device has the advantage that at least two different adjustment modes can be provided with a hair cutting device (such as continuous and stepped) and therefore enables an extremely flexible hair cutting machine or a flexible cutting set for a hair cutting machine. Furthermore, a cutting set with this selector device can also be retrofitted to a hair cutting machine. The cutting elements are preferably designed like a comb, that is, they have corresponding teeth, wherein the first cutting element is designed in particular as a fixed shearing comb which comes into contact with the skin of the person or animal or the user to be treated. The second cutting element can also be designed as a movable shearing blade. The cutting elements are adjusted between a maximum longitudinal offset (maximum cutting length) and a minimum longitudinal offset (minimum cutting length), which, for example in the case of comb-like cutting elements, leads to a minimum or maximum overlap of the cutting elements. Preferably, the blade arrangement further has a tensioning element (such as a coupling spring) for biasing the cutting elements against one another, and a carrier device which serves as a housing for the blade arrangement. The carrier device is preferably firmly connected to the first cutting element (such as with screws), so that the tensioning device can then be supported on the carrier device. The blade arrangement can also preferably comprise a guide carriage, which can then move the movable cutting element.

Preferably, the selector device can also have a selector switch designed in particular as a slide or toggle switch. Such a selector switch, in particular a slide switch, is particularly space-saving and can be designed to be inconspicuous.

The selector device further preferably has a latching device, wherein the latching device has a plurality of latching positions and wherein the latching device is engaged or disengaged in the first length adjustment mode and is engaged in the second length adjustment mode. The latching device is preferably designed like a gear or rack on the cutting length adjustment device or the guide shaft. This latching device is then preferably provided in a complementary manner on the selector switch. These teeth or latching beads preferably have a triangular or trapezoidal cross section, in particular with rounded corners or edges. Furthermore, the teeth on the cutting length adjustment device or the guide shaft and the teeth of the selector switch can slide over one another by applying force, so that a stepped adjustment of the longitudinal offset is possible.

The selector device can be designed in such a way that the longitudinal offset can be adjusted stepwise in the first length adjustment mode and the longitudinal offset can be adjusted continuously in the second length adjustment mode. The latching device is preferably disengaged in the first length adjustment mode.

The cutting length adjustment device in particular also has an adjustment lever which is connected to the second cutting element and with which the second cutting element can be displaced in the longitudinal direction relative to the first cutting element.

The adjustment lever is preferably reversibly connected to the cutting length adjustment device, so that it is designed to be detachable from the cutting length adjustment device. The adjustment lever is connected to the cutting length adjustment device in particular magnetically. This means that the adjustment lever can be easily removed from the hair cutting device and put back on, so that the lever no longer interferes with use and can be quickly reattached when an adjustment of the cutting length is desired.

The adjustment lever can be connected to the cutting length adjustment device at two different positions, in particular at the two opposite ends of the cutting length adjustment device. A hair cutting device can be used by both right-handed and left-handed people by removing the adjustment lever on one side and attaching it to the other side. For this purpose, the adjustment lever is in particular designed symmetrically along a central plane. It can also have a plug-in device on both sides with which the adjustment lever can be plugged into the cutting length adjustment device. This means that the lever does not have to be turned when changing sides of the cutting length adjustment device and other possibly more ergonomic configurations of the adjustment lever that are not symmetrical can also be used.

The adjustment lever can be moved in particular in a range from 0° to 120°, preferably in a range from 0° to 90° and particularly preferably in a range from 0° to 70°, in particular up to 62°. Furthermore, the cutting length adjustment device can be designed such that when the adjustment lever is moved in the direction of a cutting region, the longitudinal offset is reduced and when the adjustment lever is adjusted in the opposite direction, the longitudinal offset is increased.

The cutting length adjustment device is designed in particular as a guide shaft that can be rotated about an axis. Furthermore, the cutting length adjustment device preferably has at least one or two receptacles, which extend in particular radially to the axis. A plug-in cylinder of the guide carriage then preferably engages in these receptacle(s), wherein the plug-in cylinders are mounted so that they can move radially in the receptacle(s). In this way, the rotary movement of the cutting length adjustment device can be converted into a translational movement of the guide carriage.

The blade arrangement preferably further has a guide carriage which interacts with the guide shaft of the cutting length adjustment device in such a way that a longitudinal movement of the guide carriage is generated by rotating the guide shaft.

The cutting length adjustment device can also have a longitudinal offset display. This can be formed using markings (such as stripes) or numbers and is arranged in particular in the region of the lever. The longitudinal offset display is preferably designed as a scale, with the lever position at a specific point on the scale enabling a conclusion to be drawn about a specific longitudinal offset.

Furthermore, the hair cutting device preferably has a coupling spring, wherein the cutting length adjustment device is coupled to the second cutting element by means of the coupling spring. Preferably, the coupling spring is also configured to transmit the adjustment of the longitudinal offset from the cutting length adjustment device on or to the second cutting element. In particular, the coupling spring is formed by the tensioning element, so that the coupling spring is designed to press the second cutting element against the first cutting element.

The longitudinal offset is the mutual distance between two reference elements along a longitudinal axis of the hair cutting device or the cutting set. The longitudinal axis corresponds to an axis which, during operation of the hair cutting device or the cutting set, extends from the operator towards a position at which hair is cut. A transverse axis runs perpendicular to the longitudinal axis and parallel to a cutting edge. The cutting edge results from the arrangement of the first and second cutting elements and corresponds to the edge or line on which the cutting effect caused by the relative movement of the first and second cutting elements occurs.

The hair cutting device or the cutting set preferably has a selector device which comprises a latching plate which is pretensioned in the direction of the latching device and can be moved with the selector slide. In particular, the latching plate is brought into and out of engagement with the latching device by means of a ramp. For this purpose, the latching plate preferably has a spring clip. The end of the latching plate is preferably engaged in a depression in the freewheeling position.

### BRIEF DESCRIPTION OF THE FIGURES

FIG. 1a shows a hair cutting device in an isometric exploded view.

FIG. 1b shows the hair cutting device shown in FIG. 1a in a top view.

FIG. 2a shows a cutting set in an isometric view.

FIG. 2b shows the cutting set shown in FIG. 2a in a top view.

FIG. 2c shows the cutting set shown in FIGS. 2a and 2b without a carrier device in an isometric view and in a first length adjustment mode.

FIG. 2d shows the cutting set shown in FIG. 2c in a second length adjustment mode.

FIG. 2e shows the cutting set shown in FIG. 2d with a carrier device and without a first cutting element in a view from below.

FIG. 2g shows the cutting set shown in FIGS. 2d and 2e in a side sectional view.

FIG. 3a shows a selector switch in an isometric view.

FIG. 3b shows the selector switch shown in FIG. 3a in a side view.

FIG. 3c shows the selector switch shown in FIGS. 3a and 3b in a top view.

FIG. 3d shows the selector switch shown in FIGS. 3a to 3c in a view from below.

FIG. 3e shows the selector switch shown in FIGS. 3a to 3d in a view from the front.

FIG. 4a shows a guide shaft in a view from the front.

FIG. 4b shows the guide shaft shown in FIG. 4a in a top view.

FIG. 4c shows the guide shaft shown in FIGS. 4a and 4b in a sectional view from the front.

FIG. 4d shows a cross section through a plug-in cylinder and a guide carriage receptacle;

FIG. 5a shows the guide shaft shown in FIGS. 4a to 4c with an adjustment lever in a view from the front.

FIG. 5b shows the guide shaft with adjustment lever shown in FIG. 5a in a top view.

FIG. 5c shows the guide shaft with adjustment lever shown in FIGS. 5a and 5b in a sectional view from the front.

FIG. 6 shows a latching device with a complementary part of a selector switch.

FIG. 7a shows a further latching device with a complementary part of a selector switch.

FIG. 7b shows a further latching device with a complementary part of a selector switch.

FIG. 7c shows a further latching device with a complementary part of a selector switch.

FIG. 8a shows another cutting set with an adjustment lever in an isometric view.

FIG. 8b shows another cutting set with two adjustment levers in an isometric view.

FIG. 9a shows the cutting set shown in FIGS. 2c and 2f with a small longitudinal offset in an isometric view.

FIG. 9b shows the cutting set shown in FIG. 9a with a large longitudinal offset in an isometric view.

FIG. 10a shows a spring clip from a selector device in an isometric view with the selector switch in a first position.

FIG. 10b shows a spring clip from a selector device in an isometric view with the selector switch in a second position.

FIG. 11a shows various views of a cutting set with a setting lever in a position for a long cutting position.

FIG. 11b shows various views of a cutting set with a setting lever in a position for a medium cutting position.

FIG. 11c shows various views of a cutting set with an adjustment lever in a position for a short cutting position.

FIG. 12a shows various views of a cutting set with an adjustment lever in a position for a long cutting position.

FIG. 12b shows various views of a cutting set with an adjustment lever in a position for a medium cutting position.

FIG. 12c shows various views of a cutting set with an adjustment lever in a position for a short cutting position.

### DESCRIPTION OF THE PREFERRED EMBODIMENTS

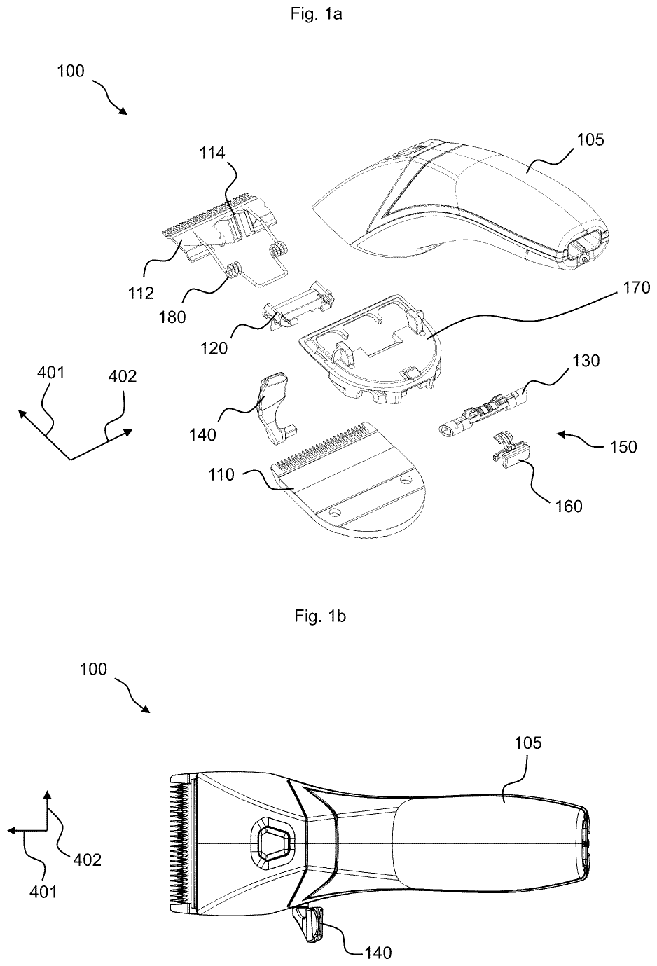

FIG. 1a shows a hair cutting device 100 in an isometric exploded view. The hair cutting device 100 has a drive device 105. The drive device 105 usually has an electric motor supplied with energy by a battery or via a cable. Furthermore, the hair cutting device 100 has a blade arrangement 250, which preferably comprises a first cutting element 110, a second cutting element 112, a guide carriage 120, a carrier device 170 and a coupling spring 180. Furthermore, a cutting length adjustment device is also provided, which is designed to adjust the longitudinal displacement between the first and second cutting elements. In the form shown here, this cutting length adjustment device has an adjustment lever 140, a selector device 150 with a guide shaft 130 and a selector switch 160. The drive device 105 serves to drive the second cutting element 112. For this purpose, a drive receptacle 114 is provided on the second cutting element 112, which can be coupled to the drive device 105. In this case, the drive receptacle 114 is designed as a double wing, between which an eccentrically rotating pin of the drive device is received. The second cutting element 112 can be moved or driven relative to the first cutting element 110 by means of the drive device 105 along and against a transverse direction 402. The second cutting element 112 can also be moved along and against a longitudinal direction 401 relative to the first cutting element 110 by means of the adjustment lever 140.

FIG. 1b shows the hair cutting device 100 shown in FIG. 1a in a top view in a completely assembled state.

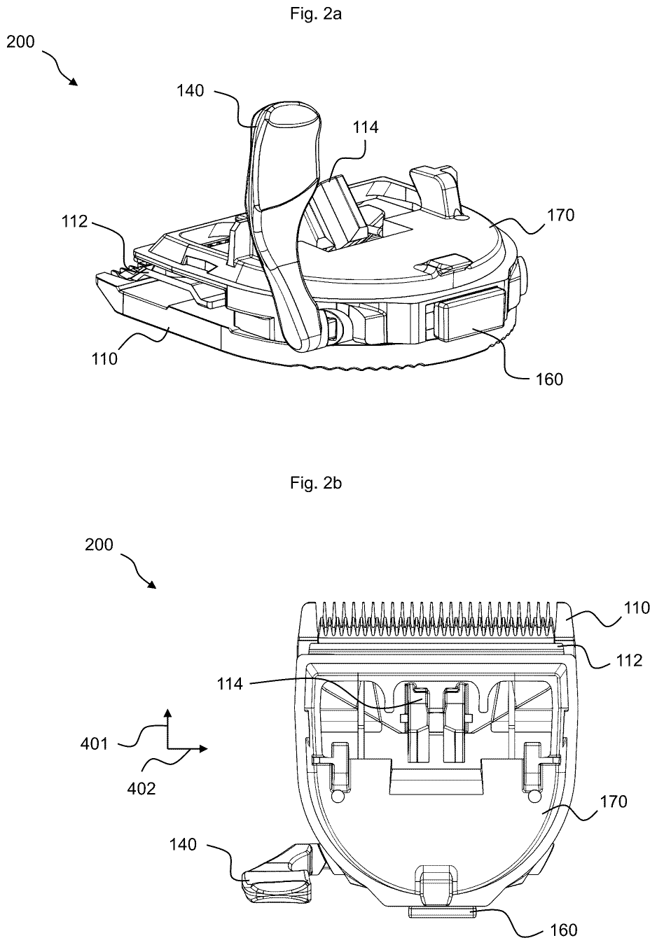

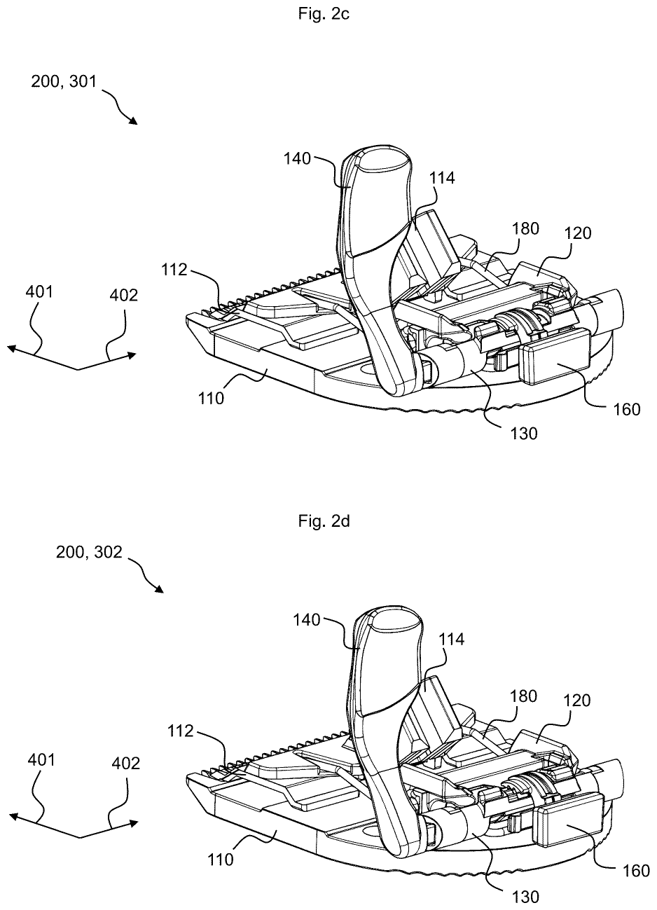

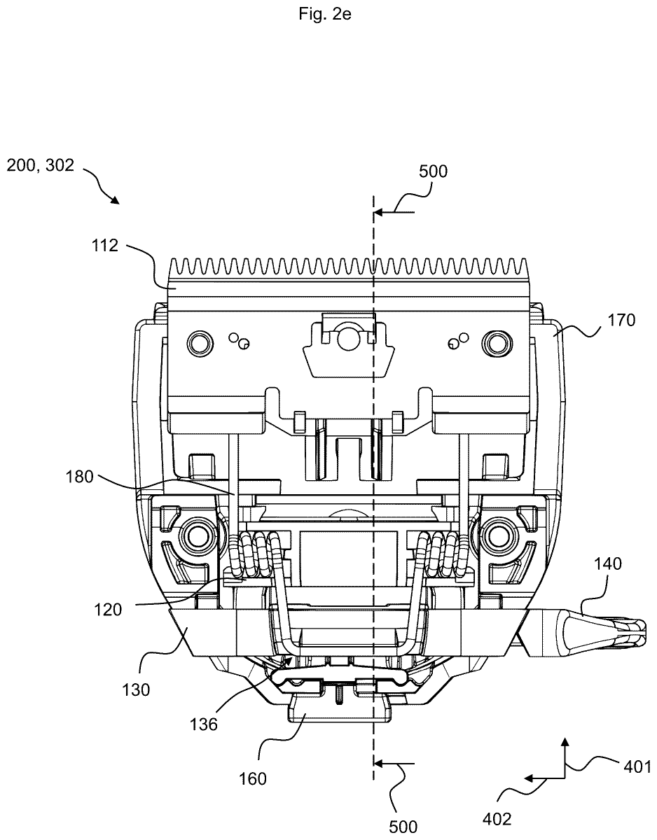

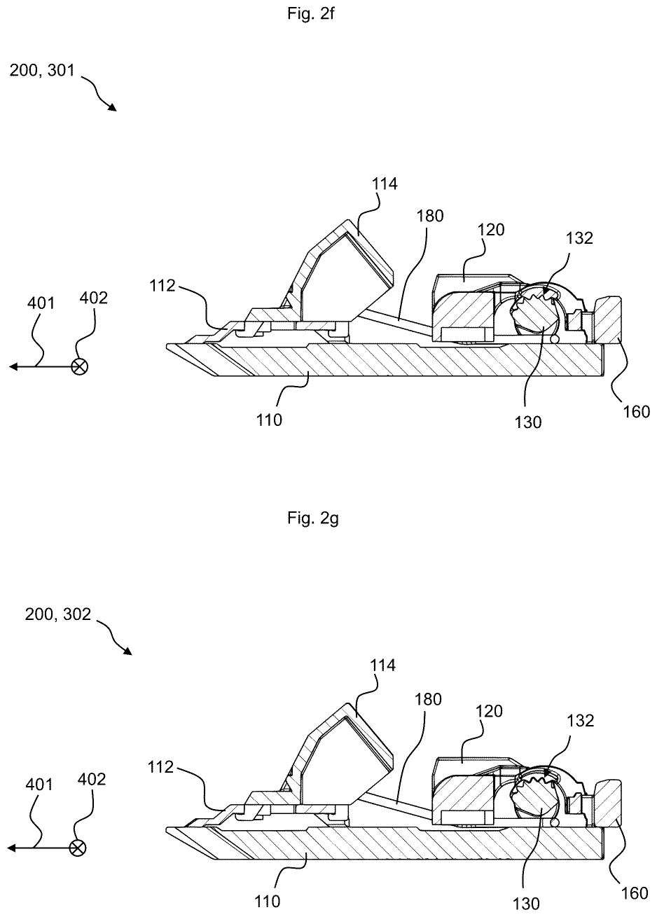

FIG. 2a shows a cutting set 200 in an isometric view. Except for the drive device 105, the cutting set 200 has the same components as the hair cutting device 100 shown in FIGS. 1a and 1b. In contrast to the hair cutting device 100 shown in FIG. 1 a, the components shown are in the assembled, namely operational, state. The carrier device 170 covers the second cutting element 112, the coupling spring 180, the guide carriage 120 and the guide shaft 130 or fixes them against the first cutting element 110 (see FIG. 1a). The selector switch 160 is exposed and therefore easily accessible to an operator. However, the selector switch 160 can also be covered, at least during operation, so that unwanted adjustment or displacement can be prevented. In the region of the drive receptacle 114, the carrier device 170 has a recess so that the drive device 105 can be coupled to the drive receptacle 114.

FIG. 2b shows the cutting set 200 shown in FIG. 2a in a top view.

FIG. 2c shows the cutting set 200 shown in FIGS. 2a and 2b without a carrier device 170 in an isometric view and in a first length adjustment mode 301. The selector switch 160 is moved against the transverse direction 402 on the guide shaft 130.

FIG. 2d shows the cutting set 200 shown in FIG. 2c in a second length adjustment mode 302. The selector switch 160 is moved against the transverse direction 402 on the guide shaft 130.

FIG. 2e shows the cutting set 200 shown in FIG. 2d with a carrier device 170 and without a first cutting element 112 in a view from below. The guide shaft 130 has a coupling spring receptacle 136 in which the coupling spring 180 is accommodated. The coupling spring 180 is also connected to the second cutting element 112. The coupling spring 180 is guided along or against the longitudinal direction 401 by means of the guide carriage 120. In this way, the second cutting element 112 can also be moved along or against the longitudinal direction.

FIG. 2f shows the cutting set 200 shown in FIG. 2c in a side sectional view 500-500. The sectional view 500-500 corresponds to the section line shown in FIG. 2e and marked with the reference number 500. The selector device 150 (see FIG. 1a) has a latching device 132 which is arranged on the guide shaft 130. The latching device 132 is in engagement with the selector switch 160. This configuration corresponds to the first length adjustment mode 301 (see FIG. 2c), in which the longitudinal offset of the first and second cutting elements 110, 112 from one another can be adjusted in steps.

FIG. 2g shows the cutting set 200 shown in FIGS. 2d and 2e in the side sectional view 500-500 also shown in FIG. 2f. The cutting set 200 is in the second length adjustment mode 302 (see FIG. 2d), that is, the selector switch 160 is not in engagement with the latching device 132. In the second length adjustment mode 302, the longitudinal offset of the first and second cutting elements 110, 112 from one another is continuously adjustable.

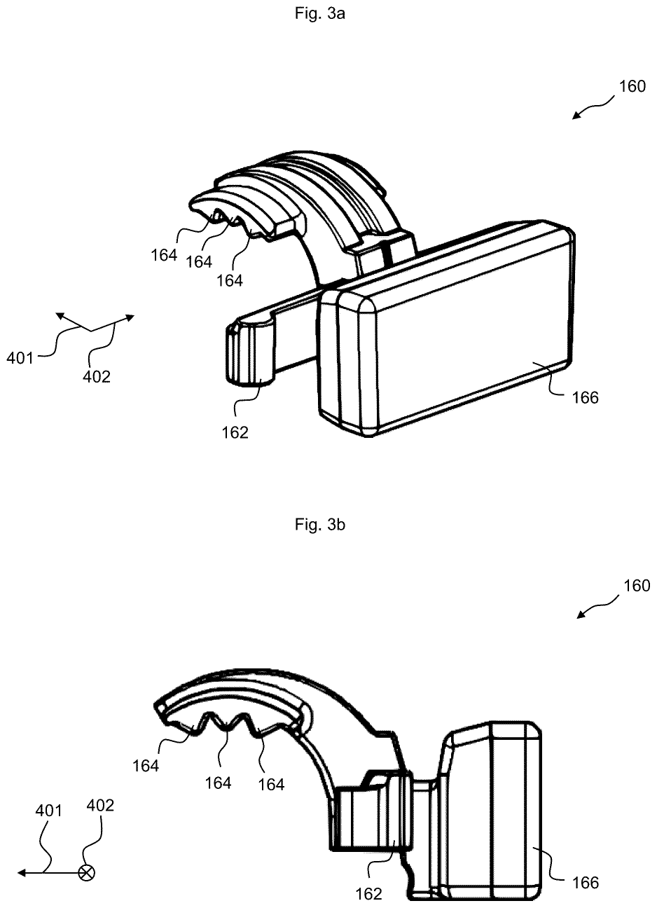

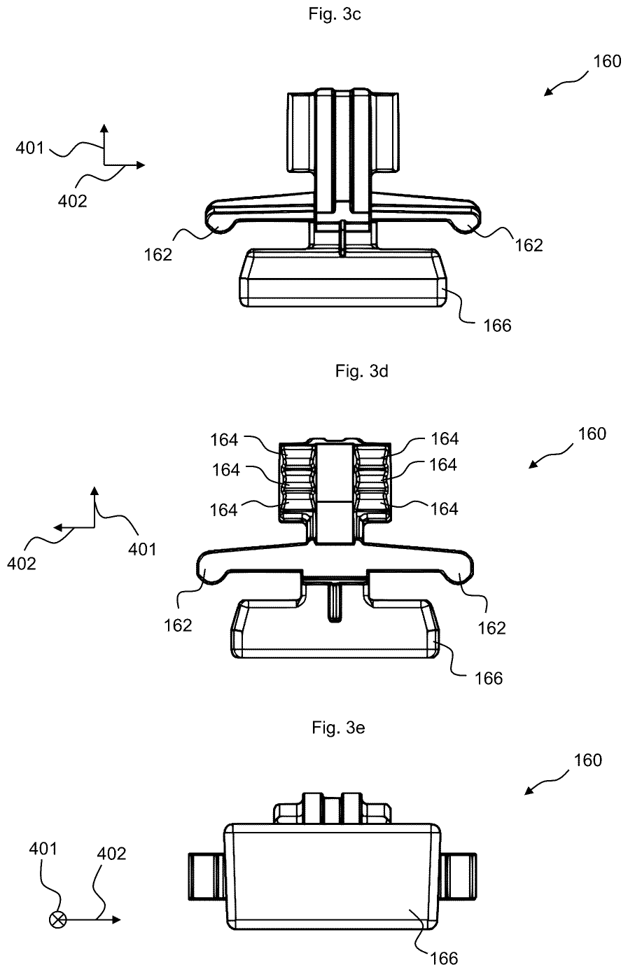

FIG. 3a shows a selector switch 160 in an isometric view. The selector switch 160 has two snap beads 162, only one of which is visible in FIG. 3a. The selector switch 160 can also have only one snap bead 162 or more than two snap beads 162 or no snap bead 162 at all. The snap bead 162 or the snap beads 162 serve to lock the selector switch 160 in a selection position, which then corresponds to a length adjustment mode, for example the first or second length adjustment mode 301, 302. The latching of the selector switch 160 can be designed in particular with the aid of the carrier device 170. For this purpose, the carrier device 170 can have one or more recesses that match the snap bead 162 or the snap beads 162, into which the snap bead 162 or snap beads 162 snap and thus lock the positioning of the selector switch 160 on the guide shaft 130. In order to move the selector switch 160 out of the respective positioning again, namely to move it counter to or along the transverse direction 402, the operator must first overcome the resistance of the snap bead 162 or the snap beads 162. The selector switch 160 also has three latching beads 164, which are designed to interact with the latching device 132. If the hair cutting device 100 or the cutting set 200 is in the first length adjustment mode 301, the three latching beads 164 prevent the guide shaft 130 from being continuously rotatable. Rather, the three latching beads 164 ensure that the guide shaft 130 can only be rotated in steps, namely from latching bead 164 to latching bead 164. Accordingly, the longitudinal offset of the first and second cutting elements 110, 112 relative to one another, namely along the longitudinal direction 401, can also only be adjusted in steps. The fineness of the adjustment of the longitudinal offset corresponds to the distance between the individual latching beads 164. In addition, fewer latching beads 164, for example one latching bead 164 or two latching beads 164, can also be provided, but also more than three latching beads 164, for example five, ten or fifteen latching beads 164 can be provided.

FIG. 3b shows the selector switch 160 shown in FIG. 3a in a side view. The three latching beads 164 are arranged essentially on a circular portion and are therefore arranged facing the latching device 132, which is located on the essentially round guide shaft 130. The two snap beads 162 protrude from the selector switch 160 against the longitudinal direction 401. Further orientations of the snap beads 162 are also possible, for example in that they protrude from the selector switch 160 along the longitudinal direction 401, or protrude along or against the transverse direction 402 or from an upper side of the selector switch 160.

FIG. 3c shows the selector switch 160 shown in FIGS. 3a and 3b in a top view. In FIG. 3c both snap beads 162 are visible. FIG. 3d shows the selector switch 160 shown in FIGS. 3a to 3c in a view from below. In FIG. 3 d it can be seen that the selector switch 160 here has three further latching beads 164, each of which is arranged opposite one of the three latching beads 164 visible in FIGS. 3a and 3b. There is a free space between the opposing latching beads 164. FIG. 3e shows the selector switch 160 shown in FIGS. 3a to 3d in a view from the front. In principle, the latching beads 164 are not fixed. A large number of latching beads 164 are preferably formed on the guide shaft 130 or the selector switch, so that a large number of adjustment levels are possible. Fewer latching beads are provided on the complementary counter element, preferably one to five latching beads, but in particular the three latching beads shown here. Three is the best number in terms of a compromise between wear, adjustment force and haptic feedback. Preferably, the latching beads of the guide shaft 130 and selector switch can also each have a different geometry, so that, for example, the selector switch has latching elements that are twice as large as the guide shaft. A finer gradation can then be achieved using finer latching elements. However, the geometry of the latching elements should be coordinated so that the latching elements can engage with one another at the same time.

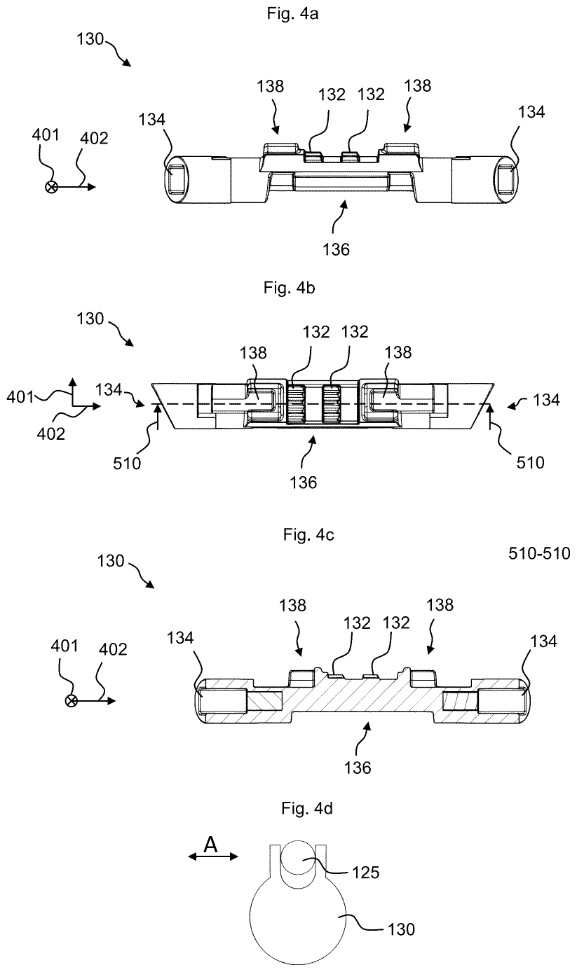

FIG. 4a shows a guide shaft 130 in a view from the front. The guide shaft 130 has two adjustment lever receptacles 134 each arranged at one side end. An adjustment lever 140 can be accommodated in each of the adjustment lever receptacles 134 in such a way that the guide shaft 130 can be rotated by means of the adjustment lever 140. The guide shaft 130 also has two guide carriage receptacles 138, into which in particular two plug-in cylinders of the guide carriage 120 can be accommodated. These plug-in cylinders 124 are arranged in particular on one arm of the guide carriage 120, which extends in the direction of the guide shaft 130. If the guide shaft 130 is rotated, the guide carriage 120 and thus the second cutting element 112 are offset along or against the longitudinal direction 401. The guide shaft 130 also has two latching devices 132. The guide shaft 130 has a smooth surface immediately next to a latching device 132 along the transverse direction 402. If the selector switch 160 or its latching beads 164 are located above the smooth surface, the longitudinal offset is continuously adjustable. The smooth surfaces are essentially as wide as the free space between the latching beads 164 visible in FIG. 3d.

FIG. 4b shows the guide shaft 130 shown in FIG. 4a in a top view. In FIG. 4b it can be seen that the two guide carriage receptacles 138 are each limited at the end with respect to the longitudinal direction 401. In this way, it can be made possible for the guide carriage 120 to be safely guided both along and against the longitudinal direction 401.

FIG. 4c shows the guide shaft 130 shown in FIGS. 4a and 4b in a sectional view 510-510 from the front. The sectional view 510-510 corresponds to the section line shown in FIG. 4b and marked with the reference number 510. It can be seen that the two adjustment lever receptacles 134 each protrude into the guide shaft 130 with respect to the transverse direction 402. In this way it can be made possible for the adjustment lever 140 to be securely accommodated in the respective adjustment lever receptacle 134.

FIG. 4d shows a cross section through a guide carriage receptacle 138, in which a plug-in cylinder 125 is arranged. The guide carriage receptacle 138 is designed to be radially longer than the plug-in cylinder 125, so that the plug-in cylinder 125 can move radially to the axis of the guide shaft 130. When the guide shaft 130 rotates, the plug-in cylinder is displaced toward or away from the cutting elements 110, 112 (see arrow A) and slides radially in the guide carriage receptacle 138.

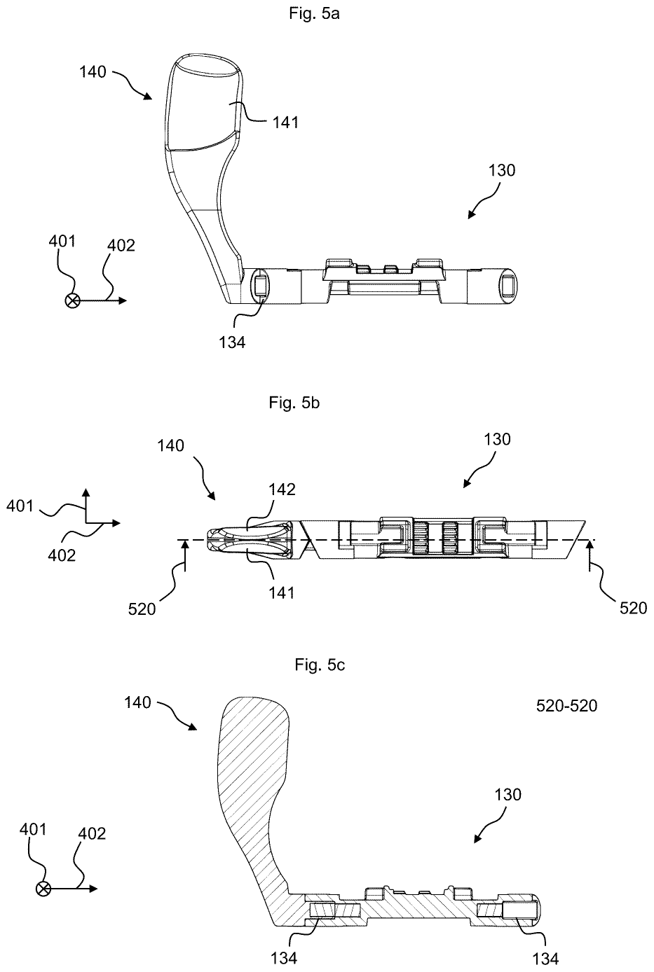

FIG. 5a shows the guide shaft 130 shown in FIGS. 4a to 4d with an adjustment lever 140 in a view from the front. The adjustment lever 140 is accommodated at its lower end in the adjustment lever receptacle 134 shown in the view on the left. The adjustment lever 140 further has a first actuation region 141, via which the adjustment lever 140 can be actuated or rotated along the longitudinal direction 401 (i.e. rotates around the axial direction 402). When the adjustment lever 140 is actuated accordingly, the guide shaft 130 is also rotated along the longitudinal direction 401 or around the axial direction 402 of the longitudinal axis of the guide shaft.

FIG. 5b shows the guide shaft 130 with adjustment lever 140 shown in FIG. 5a in a top view. The adjustment lever 140 also has a second actuation region 142, with which the adjustment lever 140 can be actuated against the longitudinal direction 401. When the adjustment lever 140 is actuated accordingly, the guide shaft 130 is also rotated against the longitudinal direction 401.

FIG. 5c shows the guide shaft 130 with adjustment lever 140 shown in FIGS. 5a and 5b in a sectional view 520-520 from the front. The sectional view 520-520 corresponds to the section line shown in FIG. 4b and marked with the reference number 520.

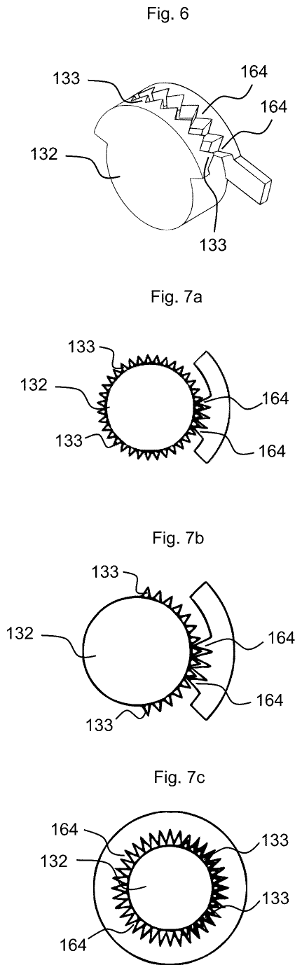

FIG. 6 shows a latching device 132 with a complementary part of a selector switch 160. FIG. 6 shows the part of the selector switch 160 in or on which the latching beads 164 are arranged. The latching device 132 has a plurality of latching teeth 133, wherein only two latching teeth 133 are shown in FIG. 6. The latching teeth 133 are designed to complement the latching beads 164. If the selector switch 160 is in engagement with the latching device 132, a latching bead 164 is respectively arranged between two latching teeth 133 or a latching tooth 133 is located between two latching beads 164, wherein an outer surface of a latching tooth 133 touches an outer surface of a respective latching bead 164. By way of the distance between the latching beads 164 or latching teeth 133 from one another, the fineness of the stepwise adjustment of the longitudinal offset in the first length adjustment mode 301 can be adjusted. With small distances between the latching beads 164 or latching teeth 133 from one another, a fine adjustability of the longitudinal offset is achieved, while large distances correspondingly result in approximate adjustment. It is also possible for both the first and second length adjustment modes 301, 302 to enable a stepwise adjustment of the longitudinal offset. For this purpose, a selector device 150 can be provided (see FIG. 1a), with which the selector switch 160 can be moved between two differently designed latching devices 132, wherein the two latching devices 132 are designed with different configurations of the latching teeth 133, each with a different mutual distance between the latching teeth 133.

FIG. 7a shows a latching device 132 with a complementary part of a selector switch 160. The latching device 132 has a plurality of latching teeth 133 which are distributed over the entire circumference of the latching device 132. This makes it possible for the guide shaft 130 to be completely rotatable about its longitudinal axis at least once. Of the latching teeth 133, only two are marked with reference numerals. In contrast, the part of the selector switch 160 shown has only four adjacent latching beads 164, of which only two are marked with reference numerals.

FIG. 7b shows a latching device 132 with a complementary part of a selector switch 160. In contrast to the latching device 132 shown in FIG. 7a, the latching device 132 shown in FIG. 7b only has latching teeth 133 distributed around approximately half its circumference. This makes it possible for the guide shaft 130 to be rotatable approximately 180°.

FIG. 7c shows a latching device 132 with a complementary part of a selector switch 160. The part of the selector switch 160 shown has a plurality of latching beads 164 or latching teeth 133 distributed around its entire circumference. The latching device 132, like the latching device 132 shown in FIG. 7b, has latching teeth 133 distributed around approximately half its circumference.

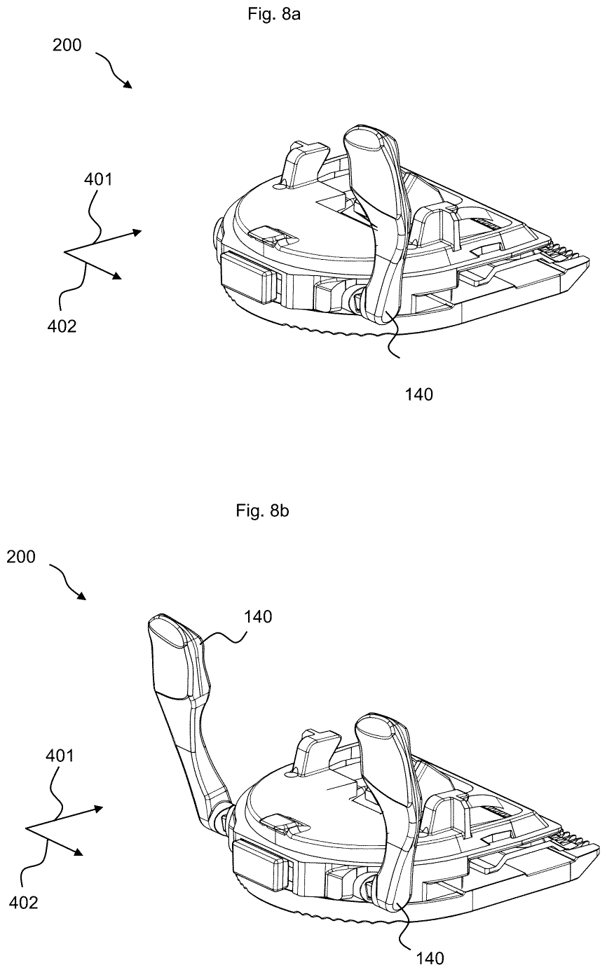

FIG. 8a shows another cutting set 200 with an adjustment lever 140 in an isometric view. In contrast to the cutting sets 200 shown in FIGS. 2a to 2e, in the cutting set 200 shown in FIG. 8a, the adjustment lever is arranged on the opposite side, namely along the transverse direction 402 at the far end of the cutting set 200 or, when viewed in the longitudinal direction 401, on the right side of the cutting set 200. For this purpose, the guide shaft 130 has two opposing adjustment lever receptacles 134, as shown in FIGS. 4a to 4c. In this way, it can be made possible for the adjustment lever 134 to be arranged on the left or right on the cutting set 200 depending on the operator's preference, for example on the right side for a right-handed operator as shown in FIG. 8a or on the left side for a left-handed operator as shown in FIGS. 2a to 2e.

FIG. 8b shows another cutting set 200 with two adjustment levers 140 in an isometric view. Such a cutting set can be easily handled by both right-handed and left-handed operators.

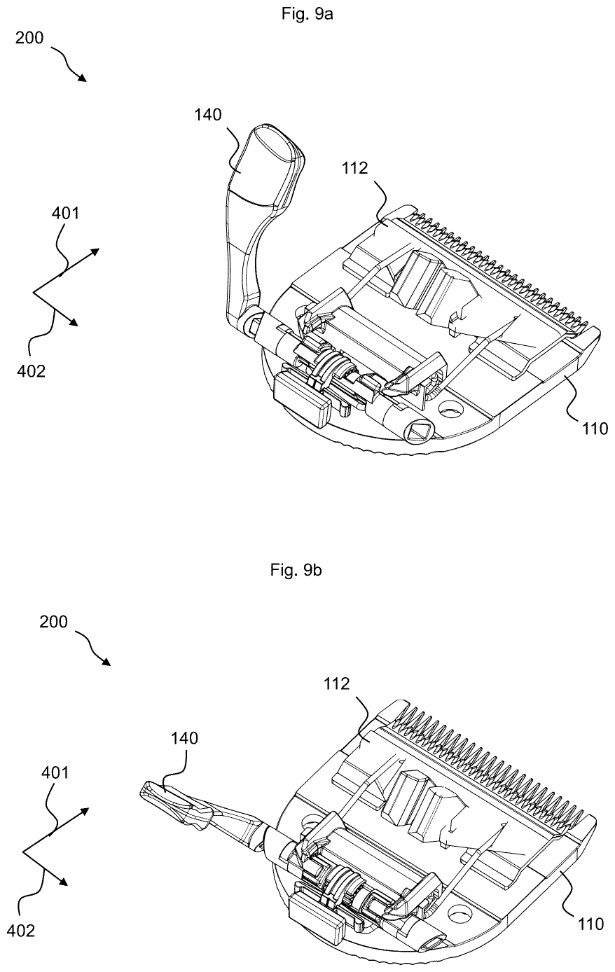

FIG. 9a shows the cutting set 200 shown in FIGS. 2c and 2f with a small longitudinal offset in an isometric view. The adjustment lever 140 is offset very far forward along the way, the guide shaft 130 is rotated along the longitudinal direction 401 and the front edges of the first and second cutting elements 110, 112 are arranged close to one another.

FIG. 9b shows the cutting set 200 shown in FIG. 9a with a large longitudinal offset in an isometric view. In contrast to the configuration shown in FIG. 9a, the adjustment lever 140 is offset very far back against the longitudinal direction 401. In this way, the guide shaft 130 is rotated against the longitudinal direction 401 and the front edges of the first and second cutting elements 110, 112 are arranged far away from one another.

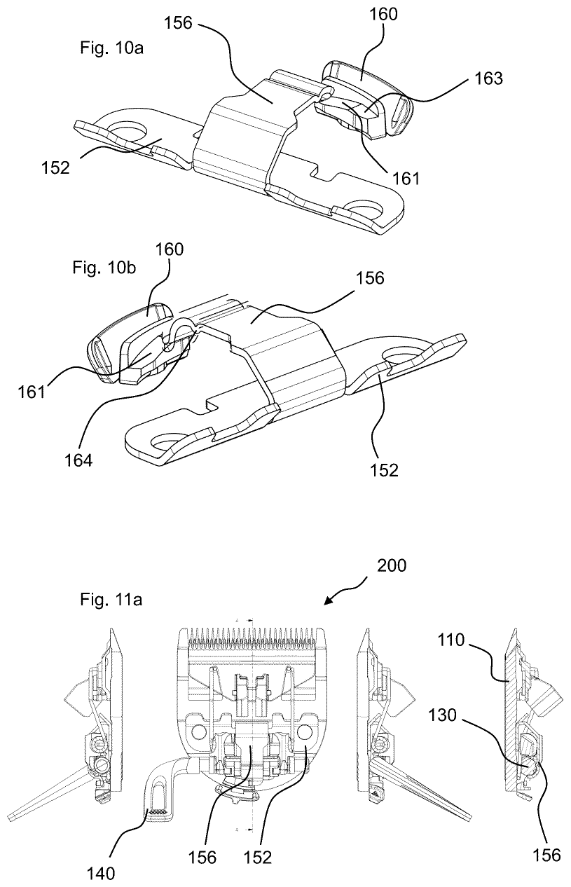

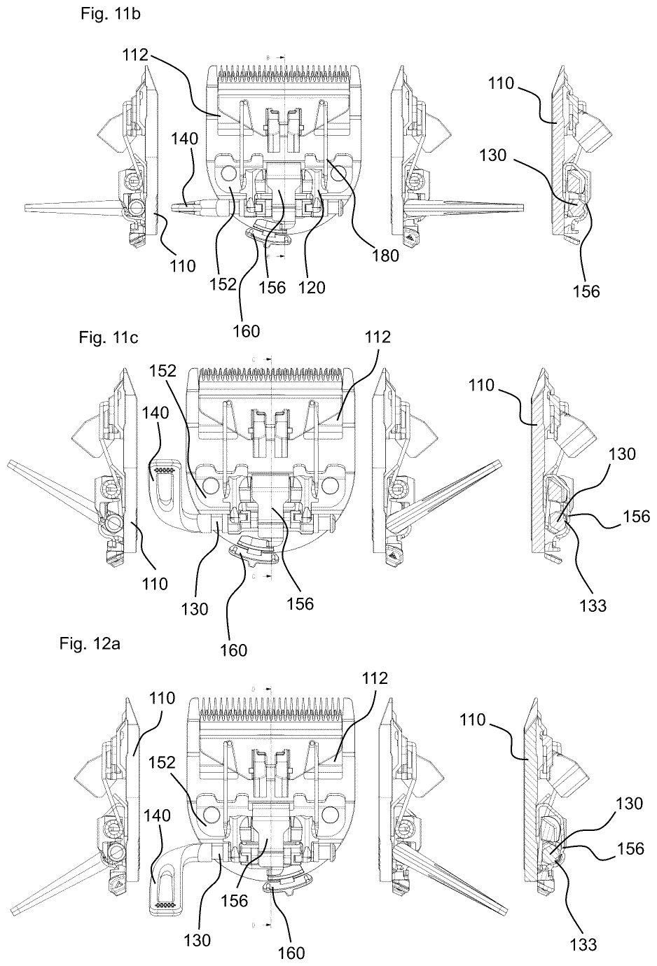

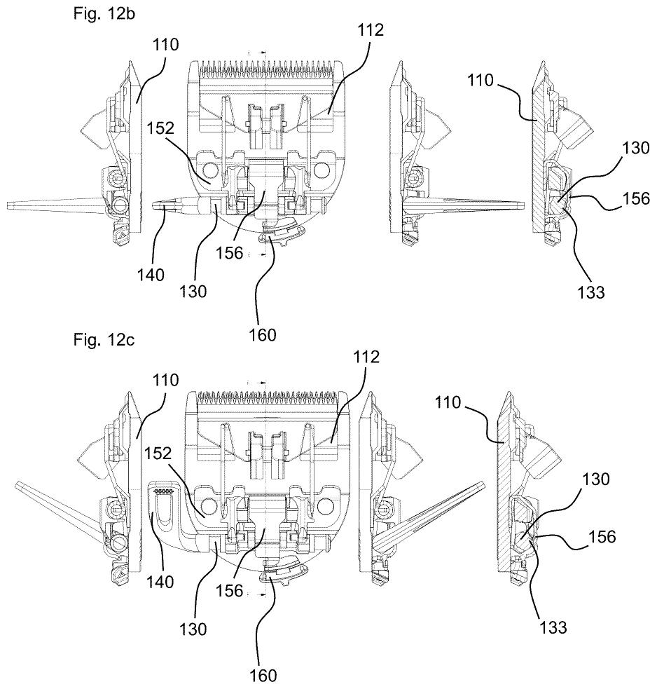

FIGS. 10a and 10b show a latching plate 152 for a selector device in which the selector switch 160 is formed separately from the latching bead 164. In this embodiment, it is possible to switch between step-by-step and continuous adjustment by engaging a latching bead 164 in the latching device 132 (e.g. between the latching teeth 133 or in a recess formed on the guide shaft 130) or moving it away from the latching device 132. In principle, one latching device 132 is sufficient for the latching plate 152, but several latching devices 132 can also be provided on the guide shaft 130 and preferably also complementarily several laterally offset latching beads 164 on the latching plate. Likewise, several latching beads can be arranged one behind the other on the latching plate. To engage the latching bead 164, the latching plate 152 has a spring clip 156, which is pretensioned in the direction of the latching device. The selector switch 160 can be in a latching position and in a freewheeling position. In the latching position, the selector switch 160 is not in engagement with the latching plate 152. The spring clip 156 of the latching plate is in engagement with the latching device 132 due to the pretension and signals, for example, the stepped length setting of the cutting blades via the interaction of the latching bead 164 with the latching teeth 133 of the latching device 132. When the selector switch 160 is then pushed into a freewheeling position, the spring clip of the latching plate is disengaged from the engagement with the latching device 132 and the mode of continuous length adjustment is provided. Here, this is accomplished such that a ramp 161 on the selector switch 160 lifts the end 154 of the spring clip 156 out of engagement with the latching device 132 by moving the selector switch 160. The end 154 of the spring clip 156 can then preferably engage in a depression 163 in the freewheeling position, so that accidental or independent slipping of the selector switch 160 can be avoided. FIGS. 11a, 11b, 11c, 12a, 12b and 12c each show two side views, a top view and a sectional view of a cutting set 200 with a latching plate 152. The cutting set 200 has the same components as the cutting sets shown in FIGS. 2a and 2b, apart from the different design of the selector switch 160 and the latching plate 152. In FIGS. 11a, 11b and 11c, the selector switch is in a latching position so that the spring clip 156 is engaged in the latching device 132 of the guide shaft 130. In FIG. 11a, a long cutting length is set in which the cutting blades are widely spaced. A medium cutting length is set in FIG. 11b and a short cutting length is set in FIG. 11c. In the sections of FIGS. 11b and 11c, it can be seen that the latching bead 164 has jumped one latching tooth 133 further in each case.

In FIGS. 12a, 12b and 12c, the selector switch is in a freewheeling position, so that the spring clip 156 is lifted out of the latching device 132 of the guide shaft 130. In FIG. 12a, a long cutting length is set in which the cutting blades are widely spaced. A medium cutting length is set in FIG. 12b and a short cutting length in FIG. 12c. The latching bead 164 is lifted off the latching device here, as the cutting length is set continuously.

The latching plate 152 can be combined with any of the previously described embodiments (one or two latching devices, all lever embodiments, etc.) as long as the engagement and disengagement described in connection with the latching plate 152 can be used instead of a lateral displacement of the latching bead 164. LIST OF REFERENCE NUMERALS
100 hair cutting device
105 drive device
110 first cutting element
112 second cutting element
114 drive receptacle
120 guide carriage
124 plug-in cylinder
130 guide shaft
132 latching device
133 latching tooth
134 adjustment lever receptacle
136 coupling spring receptacle
138 guide carriage receptacle
140 adjustment lever
141 first actuation region
142 second actuation region
150 selector device
152 latching plate
156 spring clip
160 selector switch
161 ramp
162 snap bead
163 depression
164 latching bead
166 sliding body
180 coupling spring
200 cutting set
250 blade arrangement
301 first length adjustment mode
302 second length adjustment mode
401 longitudinal direction
402 transverse direction
500-500 sectional view
510-510 sectional view
520-520 sectional view

1. A hair cutting device comprising:
a blade assembly with a first cutting element and a second, movable cutting element;
a drive device that drives the blade assembly;
a cutting length adjustment device which interacts with the second cutting element in such a way that a longitudinal offset can be adjusted between the first cutting element and the second cutting element; and
the hair cutting device has a selector device with which the cutting length adjustment device can be adjusted between at least a first length adjustment mode and at least a second length adjustment mode, wherein, in the first length adjustment mode the longitudinal offset is adjustable in a stepwise or continuous manner and, in the second length adjustment mode, the longitudinal offset can be adjusted in steps.

2. A cutting set for a hair cutting device, comprising:
a blade assembly with a first cutting element and a second, movable cutting element;
a cutting length adjustment device which interacts with the second cutting element e in such a way that a longitudinal offset can be adjusted between the first cutting element and the second cutting element; and
the hair cutting device has a selector device with which the cutting length adjustment device can be adjusted between at least a first length adjustment mode and at least a second length adjustment mode, wherein, in the first length adjustment mode the longitudinal offset is adjustable in a stepwise or continuous manner and, in the second length adjustment mode, the longitudinal offset can be adjusted in steps.

3. The hair cutting device according to claim 1, wherein the selector device further comprises a selection switch.

4. The hair cutting device according to claim 1, wherein the selector device further comprises a latching device, wherein the latching device has multiple latching positions, and wherein the latching device is engaged or disengaged in the first length adjustment mode and is engaged in the second length adjustment mode.

5. The hair cutting device according to claim 1, wherein the cutting length adjustment device is designed as a guide shaft which is rotatable about an axis.

6. The hair cutting device according to claim 4, wherein the latching device is disengaged in the first length adjustment mode.

7. The hair cutting device according to claim 1, wherein the cutting length adjustment device further comprises an adjustment lever.

8. The hair cutting device according to claim 7, wherein the adjustment lever is reversibly connected to the cutting length adjustment device.

9. The hair cutting device according to claim 8, wherein the adjustment lever is connectable to the cutting length adjustment device at two different positions.

10. The hair cutting device according to claim 7, wherein the adjustment lever is movable in a range of 0° to 120°.

11. The hair cutting device according to claim 7, wherein the cutting length adjustment device is designed such that when the adjustment lever is moved in the direction of a cutting region, the longitudinal offset is reduced and when the adjustment lever is adjusted in the opposite direction the longitudinal offset is increased.

12. The hair cutting device according to claim 7, wherein the blade arrangement further comprises a guide carriage which interacts with the guide shaft of the cutting length adjustment device such that a longitudinal movement of the guide carriage is generated by rotating the guide shaft.

13. The hair cutting device according to claim 1, wherein the cutting length adjustment device further has a longitudinal offset display.

14. The hair cutting device according to claim 1, further comprising a coupling spring, wherein the cutting length adjustment device is coupled to the second cutting element by means of the coupling spring.

15. The hair cutting device according to claim 14, wherein the coupling spring is further adapted to press the second cutting element against the first cutting element.

16. The hair cutting clip according to claim 1, wherein the selector device comprises a latching plate which is biased in the direction of the latching device and is movable with the selector switch.

17. The hair cutting set according to claim 2, wherein the selector device further comprises a selection switch.

18. The hair cutting set according to claim 2, wherein the selector device further comprises a latching device, wherein the latching device has multiple latching positions, and wherein the latching device is engaged or disengaged in the first length adjustment mode and is engaged in the second length adjustment mode.

19. The hair cutting set according to claim 2, wherein the cutting length adjustment device is designed as a guide shaft which is rotatable about an axis.

20. The hair cutting set according to claim 18, wherein the latching device is disengaged in the first length adjustment mode.
